(19) United States
(12) Patent Application Publication
(10) Pub. No.: US 2026/0229965 A1
(43) Pub. Date: Aug. 6, 2026

(54) ELECTROMECHANICAL ACTUATOR

(71) Applicant: VALEO EMBRAYAGES, Amiens (FR)

(72) Inventors: Sylvain GAUTIER, Cergy Pontoise (FR); Sylvain FAVELIER, Cergy Pontoise (FR); Mathieu LALLEMANT, Cergy Pontoise (FR)

(73) Assignee: VALEO EMBRAYAGES, Amiens (FR)

(21) Appl. No.: 19/147,540

(22) PCT Filed: Feb. 1, 2024
(86) PCT No.: PCT/EP2024/052483

§ 371 Date: Jul. 11, 2025

(30) Foreign Application Priority Data
Feb. 2, 2023 (FR) FR2300961

(51) Int. Cl. H02K 11/215; H02K 7/116; H02K 11/00

(52) U.S. Cl. CPC H02K 11/215; H02K 7/116; H02K 11/0094

(57) ABSTRACT

The present invention relates to an electromechanical actuator including an electric motor acting on a torque output element able to be coupled to a movable member of a vehicle gearbox. The torque output element is configured to rotate about its axis of rotation between a first extreme position and a second extreme position defining an actuation range. The torque output element is connected to the electric motor by drive means including a first gear wheel and a second gear wheel. The actuator further includes an electronic board which includes two sensors each facing a magnet associated with each gear wheel in order to detect the angular position of each gear wheel. The two gear wheels have a different number of teeth corresponding to the number of revolutions required for the torque output element to cover the actuation range.

The invention relates to an electromechanical actuator. More particularly, the invention relates to an electromechanical actuator which may be rotary or linear.

The invention may be applied for example to the field of actuators for a gearbox parking lock system for a vehicle, in particular an automotive vehicle equipped with an automatic gearbox, for example a hybrid vehicle. The invention also applies to a parking lock system for a reducer associated with an electric vehicle motor. The gearbox or the reducer will more generally be referred to as the transmission gearbox. This locking system is better known as a park-lock or parking lock. Such an actuator allows the transmission gearbox to be immobilized when parked, by means of a lever engaging with a toothset of the transmission gearbox.

The invention also applies to the field of actuators for a system for connecting/disconnecting components in the transmission gearbox of the abovementioned vehicles such as, for example, forks, synchronizers, selectors, etc.

It is conventional practice with these architectures for the actuator to be placed outside the transmission gearbox and for the movable member that is to be actuated to be inside the transmission gearbox. In order for the actuator to be able to act reliably on the movable member of the transmission, it is necessary to know exactly the position of the movable member in the transmission gearbox.

In the case of a rotary actuator, one solution would be to count the number of revolutions of the torque output element of the actuator in order to know the position of the movable member by having prior knowledge of the number of revolutions required for the torque output element to cover the entire actuation range of the movable member. This solution has the disadvantage that the position of the rotation needs to be stored in a memory-storage unit. In addition, in the event of a power failure, the stored position will be lost, entailing a learning procedure that is complicated to implement.

One of the aims of the invention is to propose an actuator able to solve the abovementioned problems. The actuator needs to be capable of reliably and autonomously determining the position of the movable member in the transmission gearbox over its entire actuation range without the involvement of components external to the actuator.

Thus, the invention proposes an electromechanical actuator comprising an electric motor acting on a torque output element able to be coupled to a movable member of a vehicle gearbox, the torque output element being configured to rotate about its axis of rotation between a first extreme position and a second extreme position defining an actuation range, the torque output element being connected to the electric motor by drive means comprising a first gear wheel and a second gear wheel. The actuator further comprises an electronic board which comprises two sensors each facing a magnet associated with each gear wheel in order to detect the angular position of each gear wheel.

According to the invention, the two gear wheels have a different number of teeth. More specifically, the difference between the number of teeth of the two gears corresponds to the number of revolutions required for the torque output element to cover the actuation range. Preferably, the number of revolutions required for the torque output element to cover the actuation range is a whole number.

According to the invention, the two gear wheels also have different diameters.

This design thus makes it possible to collect two signals generated by the two angular-position sensors that sense the angular position of each gear wheel for the purposes of analysis by a controller able to generate a signal corresponding to an angular position of the torque output element over its actuation range.

The movable member of the transmission gearbox is, for example, a rotary-linear device. The rotary actuation range of the torque output element of the actuator corresponds to the linear actuation range of the movable member.

According to the invention, the actuation range of the torque output element is greater than one revolution. In other words, the actuation range of the torque output element is greater than 360°.

Preferably, the two sensors are absolute sensors, for example Hall effect

According to the invention, the electric motor comprises a driveshaft which extends along an axis X1 and a drive pinion, this drive pinion meshing with the first gear wheel which is mounted so as to be rotatable about an axis X2, this first gear wheel in turn meshing with the second gear wheel mounted so as to be rotatable about an axis X3. According to one particular feature of the invention, the axes X1, X2 and X3 are parallel. This U-shaped design is particularly compact and optimized for integration into a vehicle.

According to the invention, the drive pinion and the two gear wheels have straight teeth. The teeth may equally be helical.

Thus, the angular position of the two gear wheels will be different, which makes it possible to generate different signals. These different signals are the basic data for the controller to generate a signal corresponding to an angular position of the torque output element over its actuation range.

According to another feature of the invention, the two gear wheels are guided in rotation by an intermediate frame.

According to the invention, the torque output element is a shaft rotationally connected to the second gear wheel and is configured to rotate about the axis of rotation X3. In other words, the torque output element and the second gear wheel are coaxial.

Advantageously, the electric motor, the drive pinion, the drive means with their magnets, the circuit board with the two sensors, the intermediate frame and at least partly the torque output element are housed in a housing.

The invention relates generally to a rotary or linear electromechanical actuator comprising at least one of the above features. In the case of a linear electromechanical actuator, the torque output element will be coupled to a rotary-linear device.

The invention also relates to an assembly comprising an actuator according to one of the above features and a controller, said controller being configured to generate a signal corresponding to an angular position of the torque output element over its actuation range from a comparison of the signals generated by the two angular-position sensors that sense the angular position of each gear wheel.

Preferably, the controller is located on the electronic board of the actuator.

Finally, the invention also relates to a method for determining the angular position of the torque output element of the actuator of the assembly mentioned hereinabove, the method comprising the following steps: i) collection of a first signal associated with the angular position of the first gear wheel, ii) collection of a second signal associated with the angular position of the second gear wheel, iii) comparison of the two signals by the controller, iv) generation, by the controller, of a signal corresponding to an angular position of the torque output element over its actuation range.

Further features and advantages of the invention will become apparent on reading the following description of a detailed exemplary embodiment, with reference to the appended figures:

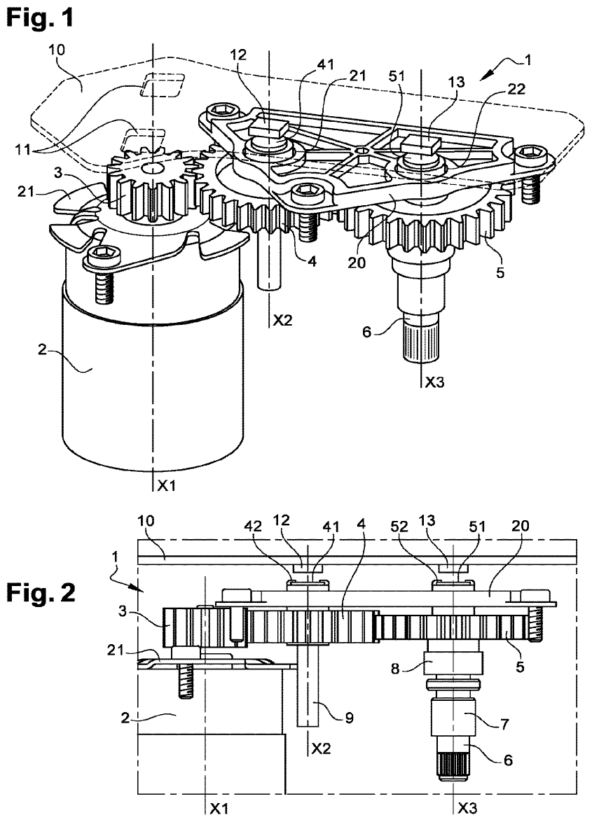

FIG. 1 shows a perspective view of the actuator according to the present invention;

FIG. 2 shows a face-on view of the actuator according to the present invention;

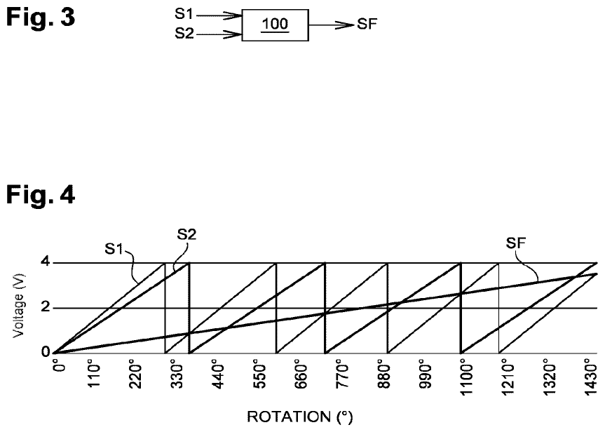

FIG. 3 is a schematic diagram of the controller associated with the actuator according to the present invention;

FIG. 4 shows a graph of the controller input and output signals.

It should be noted that the figures disclose the invention in a sufficiently detailed manner for the implementation thereof, said figures helping to better define the invention as required. However, the invention should not be limited to the embodiment disclosed in the description.

Reference is made to FIG. 1 and FIG. 2, which depict an electromechanical actuator without its housing in order to better reveal the internal elements. This actuator 1 comprises an electric motor 2 acting on a torque output element 6 able to be coupled with a translationally-movable member of a vehicle transmission gearbox. The electric motor 2 is of the brushed DC motor type and comprises a driveshaft which extends along an axis X1 and a drive pinion 3 fixed to this shaft. The electric motor 2 is pressed axially into the housing (not shown) by a compression plate 21 known per se.

The torque output element 6 is configured to rotate about its axis of rotation between a first extreme position and a second extreme position defining an actuation range. The actuation range of torque output element 6 is greater than one revolution.

The torque output element 6 is connected to the electric motor 2 by drive means. These drive means comprise a first gear wheel 4 and a second gear wheel 5. The drive pinion 3 of the electric motor 2 meshes with the first gear wheel 4 which is mounted so as to be able to rotate about an axis X2 by means of a shaft 9. The first gear wheel 4 in turn meshes with the second gear wheel 5 mounted so as to be able to rotate about an axis X3. The drive pinion 3 and the two gear wheels 4, 5 have straight teeth. The two gear wheels 4, 5 are guided in rotation by an intermediate frame 20 fixed to the housing (not shown). The torque output element 6 is a shaft rotationally connected to the second gear wheel 5 and is configured to rotate about the axis of rotation X3. The torque output element 6 is guided in rotation by a rolling bearing 8 and a plain bearing 7. There is a seal between the rolling bearing 8 and the plain bearing 7. The end of the torque output element 6 is splined so that it can be coupled to the mobile member of the transmission gearbox.

The axes X1, X2, X3 are parallel so that the actuator has a U-shaped design.

Each gear wheel 4, 5 carries a magnet 41, 51 at one of its ends. These magnets are fixed to the gear wheels preferably by clip-fastening by means of hooks 42, 52. Other means of fixing the magnets are also possible, notably adhesive bonding. The magnets 41, 51 face two sensors 12, 13 mounted on an electronic board 10. The combination of the magnet 41, 51 with its respective sensor 12, 13 makes it possible to detect the angular position of each gear wheel 4, 5. The electronic board 10 also comprises a controller 100 making it possible to process the signals S1 and S2 generated by the sensors 12, 13. This sensor and its functionalities will be discussed in connection with FIG. 3 and FIG. 4.

One particular aspect of the invention is that the two gear wheels 4, 5 have different numbers of teeth. In the present case, the first gear wheel 4 has a smaller number of teeth than the second gear wheel 5. For example, the first gear wheel 4 comprises 24 teeth and the second gear wheel 5 comprises 28 teeth. This difference of 4 teeth corresponds to the 4 revolutions that are required for the torque output element 6 to cover the actuation range between its first and second extreme positions. By virtue of this difference, the angular position of the two gear wheels 4, 5 will be different.

It is thus established that, because of the different number of teeth, when the actuator 1 is in operation, the angular position of the two gear wheels 4, 5 will be different, each gear wheel 4, 5 generating its own angular-position signal S1, S2 via the magnets 41, 51 and the sensors 12, 13. Thus the signal S1 is associated with the first gear wheel 4 and the signal S2 is associated with the second gear wheel 5.

FIG. 3 schematically shows how these two input signals are processed by the controller 100. The controller 100 is configured to generate an output signal SF corresponding to the angular position of the torque output element 6 over its actuation range from a comparison of the input signals S1, S2 based on the graph in FIG. 4.

This FIG. 4 shows a graph notably including the two input data S1 and S2 used to generate the output signal SF. Each gear wheel 4, 5 generates a signal S1, S2 the voltage of which varies according to its angular position. Because of the different numbers of teeth, an offset between these two signals is thus measured, making it possible to artificially create a signal SF by virtue of a modulo function of the voltage difference between the signals S1 and S2 divided by the difference in the number of teeth between the gear wheels 4, 5.

Although the invention has been described in connection with a particular embodiment, it is quite clear that it is by no means limited thereto and that it includes all the technical equivalents of the means described.

In the claims, the reference signs between parentheses should not be interpreted as limiting the claim.

1. An electromechanical actuator comprising an electric motor acting on a torque output element able to be coupled to a movable member of a vehicle gearbox, the torque output element being configured to rotate about its axis of rotation between a first extreme position and a second extreme position defining an actuation range, the torque output element being connected to the electric motor by drive means comprising a first gear wheel and a second gear wheel, the actuator further comprising an electronic board wherein the electronic board comprises two sensors each facing a magnet associated with each gear wheel in order to detect the angular position of each gear wheel, characterized in that the two gear wheels have a different number of teeth corresponding to the number of revolutions required for the torque output element to cover the actuation range.

2. The actuator as claimed in claim 1, wherein the actuation range of the torque output element is greater than one revolution.

3. The actuator as claimed in claim 1, wherein the electric motor comprises a driveshaft which extends along an axis X1 and a drive pinion, this drive pinion meshing with the first gear wheel which is mounted so as to be rotatable about an axis X2, this first gear wheel in turn meshing with the second gear wheel mounted so as to be rotatable about an axis X3.

4. The actuator as claimed in claim 3, wherein the drive pinion and the two gear wheels have straight or helical teeth.

5. The actuator as claimed in claim 1, wherein the two gear wheels are guided in rotation by an intermediate frame.

6. The actuator as claimed in claim 3, wherein the torque output element is a shaft rotatably connected to the second gear wheel and is configured to rotate about the axis of rotation X3.

7. The actuator as claimed in claim 1, wherein the electric motor, the drive pinion, the drive means with their magnets, the electronic board with the two sensors, the intermediate frame and at least partially the torque output element are housed in a housing.

8. An assembly comprising an actuator as claimed in claim 1 and a controller, said controller being configured to generate a signal (SF) corresponding to an angular position of the torque output element over its actuation range from a comparison of the signals (S1, S2) generated by the two angular-position sensors that sense the angular position of each gear wheel.

9. A method for determining the angular position of the torque output element of the actuator of the assembly as claimed in claim 8, wherein in that the method comprises the following steps: i) collection of a first signal (S1) associated with the angular position of the first gear wheel, ii) collection of a second signal (S2) associated with the angular position of the second gear wheel, iii) comparison of the two signals (S1, S2) by the controller, iv) generation, by the controller, of a signal (SF) corresponding to an angular position of the torque output element over its actuation range.

10. The actuator as claimed in claim 2, wherein the two gear wheels are guided in rotation by an intermediate frame.

11. The actuator as claimed in claim 2, wherein the electric motor, the drive pinion, the drive means with their magnets, the electronic board with the two sensors, the intermediate frame and at least partially the torque output element are housed in a housing.

12. An assembly comprising an actuator as claimed in claim 2 and a controller, said controller being configured to generate a signal (SF) corresponding to an angular position of the torque output element over its actuation range from a comparison of the signals (S1, S2) generated by the two angular-position sensors that sense the angular position of each gear wheel.

13. The actuator as claimed in claim 3, wherein the two gear wheels are guided in rotation by an intermediate frame.

14. The actuator as claimed in claim 3, wherein the electric motor, the drive pinion, the drive means with their magnets, the electronic board with the two sensors, the intermediate frame and at least partially the torque output element are housed in a housing.

15. An assembly comprising an actuator as claimed in claim 3 and a controller, said controller being configured to generate a signal (SF) corresponding to an angular position of the torque output element over its actuation range from a comparison of the signals (S1, S2) generated by the two angular-position sensors that sense the angular position of each gear wheel.

16. The actuator as claimed in claim 4, wherein the two gear wheels are guided in rotation by an intermediate frame.

17. The actuator as claimed in claim 4, wherein the electric motor, the drive pinion, the drive means with their magnets, the electronic board with the two sensors, the intermediate frame and at least partially the torque output element are housed in a housing.

18. An assembly comprising an actuator as claimed in claim 4 and a controller, said controller being configured to generate a signal (SF) corresponding to an angular position of the torque output element over its actuation range from a comparison of the signals (S1, S2) generated by the two angular-position sensors that sense the angular position of each gear wheel.

19. The actuator as claimed in claim 5, wherein the electric motor, the drive pinion, the drive means with their magnets, the electronic board with the two sensors, the intermediate frame and at least partially the torque output element are housed in a housing.

20. An assembly comprising an actuator as claimed in claim 5 and a controller, said controller being configured to generate a signal (SF) corresponding to an angular position of the torque output element over its actuation range from a comparison of the signals (S1, S2) generated by the two angular-position sensors that sense the angular position of each gear wheel.
